(19) United States
(12) Patent Application Publication
(10) Pub. No.: US 2009/0171537 A1
(43) Pub. Date: Jul. 2, 2009

(54) SENSOR-CONTROLLED ANTI-JAMMING DEVICE AND MOTOR VEHICLE

(76) Inventors: Thomas Kraus, Kaufering (DE); Josef Appel, Gauting (DE); Anton Dietmar Jöhl, Bad Heilbrunn (DE)

Correspondence Address: DICKINSON WRIGHT PLLC, 1875 Eye Street, NW, Suite 1200, WASHINGTON, DC, 20006, US

(21) Appl. No.: 12/298,405

(22) PCT Filed: Apr. 19, 2007
(86) PCT No.: PCT/DE2007/000694

§ 371 Date: Feb. 9, 2009

(30) Foreign Application Priority Data
Apr. 27, 2006 (DE) 10 2006 019 710.0

(51) Int. Cl. E05F 15/00

(52) U.S. Cl. 701/49

(57) ABSTRACT

The invention relates to a sensor-controlled anti jamming device for preventing jamming of an object, in particular in or for a motor vehicle. Said device comprises a body part and a motor-actuatable component which is connected in a pivotable manner to the body part, at least one support element which, when the component is in the open state, supports the component against the body part, and at least one capacitive sensor element which is arranged, when the component is open, between said component and the body part, and is configured such that in a closing step, an object can be detected in a predefined jamming area between the component and the body part.

The present invention relates to a sensor-controlled anti-trapping device for preventing trapping of an object, in particular in or for a motor vehicle. The invention also relates to a corresponding motor vehicle.

### TECHNICAL BACKGROUND

Components in a motor vehicle which can be adjusted by motor are moveable devices such as, for example, sunroofs, tilt and slide sunroofs, side doors, sliding doors and tailgates. The invention and the problems on which it is based will be described below with reference to an anti-trapping device in a vehicle and here to an anti-trapping device in a tailgate of a motor vehicle without, however, restricting the invention to this.

A motor drive in such a tailgate is configured to move said tailgate from a closed position into an opened position, and vice versa. During a closing process, a trapping event may occur in which, for example, a person's hand can be placed in the gap between the tailgate and the vehicle body. In order to detect in good time such situations which frequently lead to injuries, and therefore avoid them, electrically activatable components have safety systems.

There are a large number of different embodiments and variants of such safety systems for making available anti-trapping protection, and said embodiments and variants differ from one another essentially in the method of detection of a hazardous situation. In the field of the motor vehicles, anti-trapping devices in motor-operated components frequently have proximity sensors which operate in a capacitive fashion. German patent applications DE 103 28 929 A1 and DE 40 04 353 A1 respectively describe anti-trapping devices, in particular for window lifters in a motor vehicle, which use capacitive sensors.

The corresponding capacitive sensor electrodes in the anti-trapping devices can, for example, be integrated into corresponding rubber profiles of the tailgate, which profiles are attached along the clamping edge on the tailgate or the corresponding edge of the vehicle body which is located opposite. Such an arrangement is described, for example, in DE 10 2004 023 285 B3. Alternatively, the capacitive sensor electrodes can also be embodied as strips, such as is described in 10 2005 043 543.3, and for which a patent has been applied for by the applicant, but which has not yet been published on the application date of the present patent application.

Motor-activated tailgates frequently have support elements which are provided laterally on the tailgate. These support elements are configured to support the tailgate in the opened state. Although the motor vehicle usually has a safety device with anti-trapping device protection, which has capacitive sensor elements, in the region of the tailgate, it is, however, problematic that depending on the location at which the sensor elements are provided there is a certain degree of shielding of a partial region between the tailgate and the vehicle body by the support element itself, which is typically composed of metal. In this shielded region, the anti-trapping protection is not ensured, or is ensured only to a limited degree.

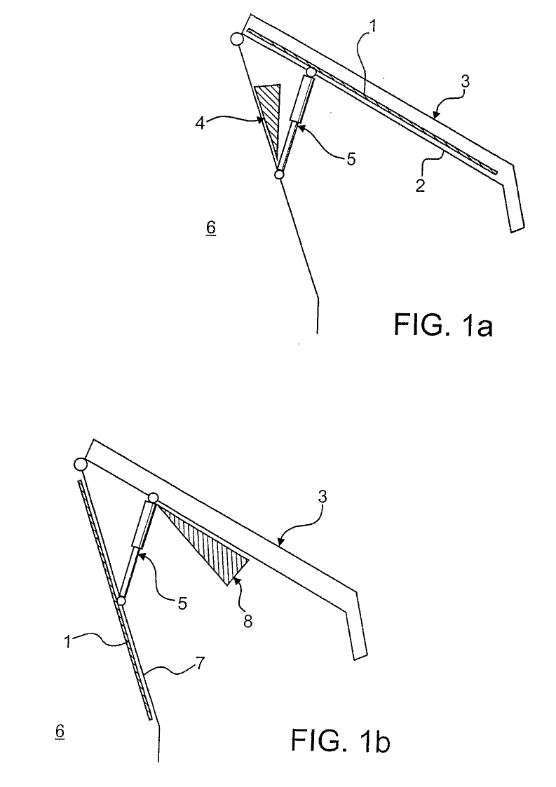

This problem will be explained briefly with reference to FIGS. 1a, 1b. In FIG. 1a, the sensor element 1 is arranged on an edge 2, where there is a risk of trapping, of the tailgate 3. In a region which is denoted by reference symbol 4 in FIG. 1a, between the support element 5 and a vehicle body part 6, a region which cannot be monitored by the sensor element 1 occurs with this arrangement. Conversely in the example in FIG. 1b, the sensor element 1 is arranged on an edge 7, where there is a risk of trapping, of the vehicle body part 6. Here, the region which is denoted by reference symbol 8, between the support element 5 and the tailgate 3, cannot be monitored by the sensor element 1 or can only be inadequately monitored by it. In these two regions 4, 8, a hazardous trapping gap is therefore produced in which anti-trapping protection is not ensured or is only ensured to a limited degree. This is a state which should be avoided as far as possible.

Against this background, the object of the present invention is to provide anti-trapping protection which can be produced as simply as possible and permits, in particular, as far as possible complete monitoring of the entire region where there is a risk of trapping.

### SUMMARY OF THE INVENTION

According to the invention, this object is achieved by means of an anti-trapping device having the features of patent claim 1 and/or by means of a motor vehicle having the features of patent claim 16.

Accordingly, there is provision of the following:

A sensor-controlled anti-trapping device for preventing trapping of an object, in particular in or for a motor vehicle, having a vehicle body part and a motor-activated component which is pivotably connected to the vehicle body part, having at least one support element which supports the component against the vehicle body part in an opened state of the component, and having at least one capacitive sensor element which, in the opened state of the component, is arranged between the component and the vehicle body part, and which is configured to detect an object located in a predetermined trapping region between the component and the vehicle body part during a closing process.

A motor vehicle having a sensor-controlled anti-trapping device according to the invention.

The idea on which the present invention is based consists in the fact that a sensor element for monitoring regions where there is a risk of trapping is additionally or alternatively also arranged in the direct region about a support element or a pivoting axle for a motor-activated component. As a result, regions which are, for example, shielded by the support element or else by other vehicle body regions are preferably also monitored. With the present invention it is therefore possible, by comparison with known solutions, to make available significantly improved, optimum anti-trapping protection which is, in particular, also very easy to implement in terms of manufacturing technology and is therefore cost-effective.

Advantageous refinements and developments of the invention emerge from the further sub-claims and from the description in conjunction with the drawings.

One preferred refinement provides that the component is pivotably attached to the vehicle body part via a pivoting axle, and in that the predetermined trapping region denotes a first gap in the direct vicinity of the pivoting axle. Additionally or alternatively, the predetermined trapping region denotes a second gap between the vehicle body part and the support element and/or a third gap between the support element and the component.

In one refinement of the invention, the support element is electrically insulated from the component and/or the vehicle body part.

In a first, very advantageous refinement of the invention, the sensor element is part of the support element. The sensor element can be attached here to the support element by means of a bonding layer and/or clip closure and/or screwed connection and/or plug-in connection.

In a second refinement of the invention, a laterally arranged panel element is provided between the component and/or the vehicle body part, wherein the sensor element is part of the panel element. The panel element is preferably attached to the support element here.

The panel element is typically attached in an electrically insulated fashion to a pivoting axle for the tailgate. It would also alternatively be conceivable for the panel element to be attached in an electrically insulated fashion to the component or to the vehicle body part in the vicinity of a pivoting axle for the component.

One particularly preferred refinement of the invention provides that a further sensor element is provided which is arranged on that edge of the component where there is a risk of trapping and/or on that edge of the vehicle body part where there is a risk of trapping.

In one preferred refinement, the anti-trapping device has a contactless proximity sensor. This proximity sensor is preferably a sensor which operates in a capacitive fashion. Other contactless proximity sensors, for example on an infrared, ultrasonic or radar basis, would also be conceivable here.

In one refinement of the invention, the sensor electrode is embodied as a conductive coating and/or as a conductive wire electrode and/or as a conductive piece of sheet metal and/or as a conductive (metal) foil. This type of sensor electrode can be integrated into the material of the component, of the vehicle body part or of the support element, for example through encapsulation by injection molding.

Typically, but not necessarily, the support element has a gas pressure spring. Alternatively, it would also be conceivable for the support element to be acted on by a spring-elastic element.

In one typical refinement, the anti-trapping device has an open-loop control device. This open-loop control device, which typically also contains an evaluation circuit for evaluating the sensor signals, controls the anti-trapping protection as a function of the evaluation of the sensor signals. Typically, but not necessarily, the open-loop control device is arranged within the motor-activated component. In one preferred development the open-loop control device is a component of a control unit for controlling the opening and/or closing process of the component.

The component is typically provided with a drive motor which moves the motor-activated component as a function of an open-loop control operation of the open-loop control device. For an opening and/or closing process of the component the drive motor acts on an adjustment mechanism, wherein the component is connected to this adjustment mechanism preferably via a driver.

In one typical refinement, the motor-activated component is embodied as a tailgate or as a trunk lid, which can be activated by means of an electric motor drive. Further applications are, for example, electric sliding doors, side doors, sunroofs and/or tilt and slide sunroofs of a motor vehicle and the like.

### CONTENTS OF THE INVENTION

The invention will be explained in more detail below with reference to the exemplary embodiments given in the schematic figures of the drawings, in which:

FIGS. 1a, 1b are lateral illustrations of the rear part of a vehicle explaining the general problems;

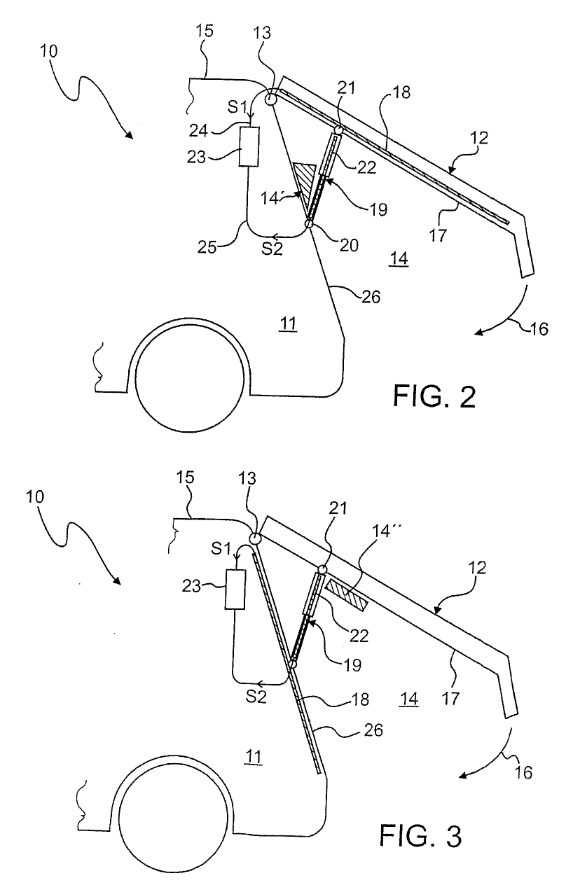

FIG. 2 is a lateral illustration of the rear part of a vehicle explaining a first exemplary embodiment of the anti-trapping device according to the invention;

FIG. 3 is a lateral illustration of the rear part of a vehicle explaining a second exemplary embodiment of the anti-trapping device according to the invention; and

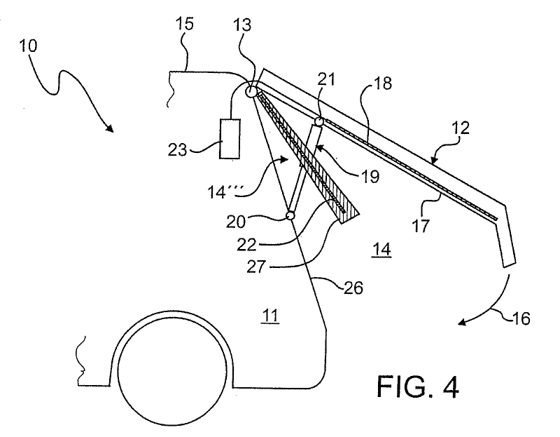

FIG. 4 is a lateral illustration of a rear part of a vehicle explaining a third exemplary embodiment of the anti-trapping device according to the invention.

Identical and functionally identical elements, features and signals are, unless stated otherwise, provided with the same reference symbols in the figures of the drawings.

### DESCRIPTION OF EXEMPLARY EMBODIMENTS

FIGS. 2-4 are lateral illustrations of the rear part of a vehicle explaining exemplary embodiments of the anti-trapping device according to the invention.

FIGS. 2-4 show, by way of example, the rear part of a motor vehicle 10 of which only a portion is illustrated. The motor vehicle 10 has a rear-end vehicle body part 11 to which a pivotable tailgate 12 is attached. The tailgate 12 can be moved into an open and closed position in the pivoting direction 16 by means of a rotational axle 13 which is provided on the roof 15 of the motor vehicle 10, for example a pivot joint 13 which defines a pivoting axis. For this a motor drive (for example in the form of an electric motor) is provided which activates the tailgate 12 by motor by means of an adjustment mechanism (not illustrated in FIGS. 2-4). Depending on the direction of rotation of the motor drive, an opening process or a closing process can therefore be respectively implemented in or counter to the pivoting direction 16. This opening and closing of the tailgate 12 which is activated by means of the drive motor can be implemented in a large number of embodiments and variants, for example by direct engagement of the drive on the rotational axle 13 or alternatively by means of a lever driver which is attached to the tailgate 12 and to the motor vehicle 10 and is activated by means of the drive. In the present application, more details are not given on the precise configuration of this drive motor with an adjustment mechanism.

In the examples shown in FIGS. 2-4, the tailgate 12 is in the opened state, i.e. it is in a position in which it is pivoted away from the vehicle body part 11 by means of the pivot joint 13. In this opened state of the tailgate 12, a region 14 is produced which is located between the tailgate 12 and the vehicle body part 11. In order to avoid trapping of an object, for example of a hand, in this region 14 in the case of a closing process of the tailgate 12, the motor vehicle 10 has, in the rear part 12, an anti-trapping device according to the invention, more details on which anti-trapping device will be given below.

In the exemplary embodiment in FIG. 2, a first sensor element 18 is arranged in the region of an edge 17, where there is a risk of trapping, of the tailgate 12. In FIG. 2, this first sensor element 18 is arranged more or less along the entire edge 17, where there is a risk of trapping, of the tailgate 12. This sensor element 18 is, for example, part of a capacitive proximity sensor. The sensor element 18 is configured to monitor the region 14 between the tailgate 12 and vehicle body part 11 with respect to a situation where there is a risk of trapping when the tailgate 12 closes.

In order to support the tailgate 12 against the vehicle body part 11, a support element 19 is provided which, in the opened state of the tailgate 12, is arranged in the region 14 between the gate 12 and the vehicle body part 11. In the present exemplary embodiment, the support element 19 contains a gas pressure spring. The support element 19 is connected to these elements 11, 12 via a first attachment point 20 on the vehicle body side and via a second attachment point 21 on the tailgate side.

According to the invention, the support element 19 has a further sensor element 22. This further sensor element 22 is configured to monitor a region 14′ between the support element 19 and the vehicle body part 11 for a situation where there is a risk of trapping. The first sensor element 18 is also designed to monitor the region 14 between the support element 19 and vehicle body part 11. However, due to the presence of the typically metal, and therefore shielding, support element 19, the regions 14′ in the vicinity of the attachment point 20 are not monitored, or are only inadequately monitored, using the sensor element 18, for a situation where there is a risk of trapping. For this, the further sensor element 22 is provided, which sensor element 22 is especially configured for monitoring the region 14′ where there is a risk of trapping, in the vicinity of the attachment point 20. Optimum monitoring in order to prevent trapping can therefore be made available over the entire region 14, 14′ between the tailgate 12 and the vehicle body part 11.

The support element 19, which, for example, is mainly composed of a metal or a metal alloy, is itself preferably used as a sensor electrode for the further sensor element 19. However, for this purpose the attachment points 20, 21 of the support element 19 have to be embodied so as to be electrically insulated from the vehicle body part 11 on the one hand and from the tailgate 21 on the other. This can be implemented, for example, by forming the attachment points 20, 21 of the support element 19 by means of spherical heads or rollers which contain an electrically insulating material, for example plastic, at least on their outer surfaces. Additionally or alternatively, the corresponding bearing shells, which serve to hold these spherical heads or rollers, can also have an electrically insulating material on their outer surfaces.

If the tailgate 12 and/or the vehicle body part 11 are composed of an electrically insulating material at least in the region at which the support element 19 is attached to these elements via the attachment points 20, 21, it is also possible to dispense with the insulation of the bearings of the support element 19.

Instead of using, as a further sensor element 22, an electrically conductive support element 19, which is for example composed of metal, it is also possible to provide a separate sensor element 22 which is, for example, attached to or provided on etc. the support element 19. For example, the further sensor element 22 can be bonded by means of a bonded connection, plugged on by means of a plug-type connection, or clipped on by means of a clip connection etc. to the support element 19. The advantage of a plug-type or clip connection is that the corresponding further sensor element 22 can easily be removed again, which is advantageous, in particular in terms of maintenance.

An evaluation and open-loop control device 23 is illustrated schematically in the vehicle body part 11. This evaluation and open-loop control device 23 serves to evaluate the sensor signals S1, S2 which are generated by means of the sensor elements 18, 22. For this purpose, the evaluation and open-loop control device 23 is connected to the first sensor element 18 via a first connecting line 24. The evaluation and open-loop control device 23 is connected to the further sensor element 22 via a further connecting line 25. The sensor signals S1, S2 are fed via the connecting lines 24, 25 to the evaluation device 23 for evaluation. In the case of the connecting line 25, said line can, for example, be led out of the support element 19 through corresponding drilled holes or cutouts within the shell or the spherical element in the region of the attachment point 20.

The evaluation and open-loop control device 23 is configured to perform evaluation and open-loop control of the opening and closing process of the tailgate 12. In the case of a hazardous trapping situation in which, for example, trapping in the region of the gap 14 between the tailgate 12 and motor vehicle 10 is imminent, this is detected by means of the evaluation and open-loop control device 23. The evaluation and open-loop control device 23 is then capable of activating anti-trapping protection, for example in that, in the case of closing of the tailgate 12, said tailgate 12 is opened again or the closing process is at least stopped.

The evaluation device can, of course, also be made separate from the open-loop control device 23, for example the evaluation device can be part of the respective sensor element 18, 22 itself. It would also be conceivable to arrange the evaluation and open-loop control device 23 in the tailgate 12.

The evaluation and open-loop control device 23 can be formed, for example, as a program-controlled device, for example as a microcontroller or microprocessor, and is typically a component of a control unit.

Two support elements 19 are typically provided in the rear part. Since these support elements 19 are typically attached symmetrically to lateral edges of the tailgate 12, a change in capacitance which originates from a change in position of the tailgate 12 and which is detected by the corresponding sensor elements 18, 22 can be gated out by forming differences between the corresponding sensor signals. If a situation is present where there is no risk of trapping whatsoever, this formation of differences results in a zero signal. A situation where there is a risk of trapping is detected only if a signal which is different from zero is detected, for example using a corresponding switching threshold for the difference signal, and the corresponding measures for anti-trapping protection can be initiated. These measures may be, for example, to stop the electric motor for the tailgate 12 which is activated by electric motor or else to open the tailgate 12 again using the electric motor.

The sensor elements 18, 22 can, for example, be embodied from a piece of sheet metal, a wire, an electrically conductive layer or the like. In the region of the tailgate 12 and/or of the vehicle body part 11, the corresponding sensor element 18 can be provided on or attached to the surface of these elements or else arranged in the material of these elements if this material is not electrically conductive. In the case of an electrically conductive material for the elements 11, 12, the corresponding sensor element 18 can also be integrated into a sealing material on the corresponding edges 17, 26 where there is a risk of trapping.

In contrast to the exemplary embodiment in FIG. 2, in the exemplary embodiment in FIG. 3 the sensor element 18 is arranged along an edge 26, where there is a risk of trapping, of the vehicle body part 11. While this sensor element 18 is configured to monitor wide ranges 14 between the tailgate 12 and vehicle body part 11 for a situation where there is a risk of trapping, the further sensor element 22 which is arranged in the support element 19 serves the purpose of additionally monitoring a region 14″. This additional region 14″ is located on the tailgate side in the direct vicinity of the attachment point 21 between the support element 19 and the tailgate 12. In this arrangement of the sensor element 18 in the region of the vehicle body part 11, optimum monitoring of the region 14 for a situation where there is a risk of trapping is therefore also ensured.

In the exemplary embodiment in FIG. 4, the support element 19 itself cannot contain a further sensor element 22, as is the case in the exemplary embodiments 2 and 3. The function of the further sensor element 22 is carried out here by a panel element 27 which is attached to the support element 19. This panel 27 extends from a region directly in the vicinity of the pivot joint 13 at least partially into the region 14. The panel 27 is spaced apart here from the tailgate 12 on the one hand and from the vehicle body part 11 on the other. The panel element 27 contains the further sensor element 22, which is preferably arranged over the entire length of the panel 27. The panel 27 is typically connected in a moveable fashion to the support element 19 and the pivoting axle 13 so that during a closing process the panel element 27 moves, for example, along a rail on the support element 19 in the direction of the vehicle body part 11. The panel 27 is preferably clipped onto the support element 19. It is also essential here that the panel 27 is, in particular, embodied so as to be electrically insulated from the vehicle body part 11 and the tailgate 12, and typically also from the support element 19. This can be done, for example, by an electrically non-conductive attachment of the panel 27 to the support element 19 and/or to the pivoting axle 13.

The panel 27 is preferably embodied in such a way that in the closed state of the tailgate 12 it can be countersunk in a cutout, especially provided for that purpose, in the vehicle body part 11 or the tailgate 12. Additionally or alternatively it would also be conceivable for the panel 27 to be embodied in the form of folding bellows which can unfold completely when opening occurs and be folded together completely when closing occurs.

The panel element 27 can be completely composed of a conductive material, for example a metal or a metal alloy. In this case, the entire panel 27 would carry out the function of the further sensor element 22. Additionally or alternatively it would also be conceivable for the panel 27 to have suitably shaped, electrically conductive conductor structures which comprise the function of the further sensor element 22.

The inventive panel 27 which contains the further sensor element 22 can preferably monitor the entire region 14′″ between the tailgate 12, the vehicle body part 11 and the support element 19 for a situation where there is a risk of trapping. In this context, in particular the region which is otherwise critical in the direct vicinity of the pivot joint 13, which can otherwise only be monitored inadequately, is now monitored to an optimum degree. Since the panel element 27 in FIG. 4 protects the entire region 14′″, the first sensor element 18 can be dispensed with in this region of the tailgate 12 (or of the vehicle body part 11).

The electrical connection of the panel element 27 to the evaluation and open-loop control device 23 can be implemented by means of a connecting line which is especially provided for that purpose, as is illustrated in analogous fashion in FIGS. 2 and 3. It is also advantageous that complex cabling is not necessary for the further sensor element 22 within the panel 27. Contacts can be formed here, for example, very easily by clipping a sensor element 22 onto the panel 27 or by some other type of surface contact of the sensor element 22, since good capacitive coupling in the region of several piko-Farads is already sufficient for the reliable functioning of the sensor element 22. This would also be conceivable by means of a thin insulating layer, for example an electrolytically oxidized layer, a thin surface coating etc. It is very easily possible to form a capacitive sensor element in the case of the exemplary embodiment in FIG. 4. The described formation of contacts can, however, also be extended or applied to the exemplary embodiments in FIGS. 2 and 3 by virtue of the fact that the formation of contacts which has just been described is also used for electrical connection of the support elements 19 to the further sensor element 22 in the examples in FIGS. 2 and 3.

Although the present invention has been described above with reference to preferred embodiments and variants, it is not to be considered as being restricted thereto but rather can, of course, be modified in any desired way.

In particular, the invention is not to be considered as being restricted to the specific embodiments of the sensor element or to the materials used for the sensor elements or to the materials used for the tailgate, the vehicle body part or the support element. Any material or any object which is electrically conductive can be used as a sensor element, and in this context materials which can very easily be processed in terms of manufacturing technology and attached in terms of mounting technology are preferably used. Such a sensor which emits electromagnetic signals and/or receives them and evaluates them can be used as sensor elements.

The invention is also not exclusively restricted to a tailgate in a motor vehicle but rather can, of course, also be applied to other motor-activated components such as, for example, side doors, sunroof/tilt and slide sunroof structures, trunk lids, engine hoods and the like. Furthermore, the invention is not restricted exclusively to the field of automobiles but rather can also be used advantageously in other vehicles such as trucks, buses, train cars and the like.

The drive motor system and adjustment motor system which are described in the patent application are to be understood as merely by way of example and they can be modified as desired without involving an inventive step by a person skilled in the art.

### LIST OF REFERENCE SYMBOLS

1 Sensor element
2 Edge where there is a risk of trapping
3 Tailgate
4 Region where there is a risk of trapping
5 Support element
6 Vehicle body part
7 Edge where there is a risk of trapping
8 Region where there is a risk of trapping
10 Vehicle, motor vehicle
11 Vehicle body part (in the rear part of the vehicle)
12 Tailgate, motor-activated component
13 Pivot joint, pivoting axle
14 Region between tailgate and vehicle body part
14′-14″″Critical regions
15 Roof region of the motor vehicle, roof
16 Pivoting direction
17 Edge where there is a risk of trapping
18 Sensor element, sensor electrode
19 Support element
20, 21 Attachment points (of the support element)
22 Further sensor element
23 Evaluation and open-loop control circuit
24, 25 Connecting lines
26 Edge where there is a risk of trapping
27 Panel, panel element
S1, S2 Sensor signals

1. A sensor-controlled anti-trapping device for preventing trapping of an object, in particular in or for a motor vehicle,
having a vehicle body part and a motor-activated component which is pivotably connected to the vehicle body part,
having at least one support element which supports component against the vehicle body part in an opened state of the component, and
having at least one capacitive sensor element which, in the opened state of the component, is arranged between the component and the vehicle body part, and which is configured to detect an object located in a predetermined trapping region between the component and the vehicle body part during a closing process.

2. The device of claim 1, characterized in that the component is pivotably attached to the vehicle body part via a pivoting axle, and in that the predetermined trapping region denotes a first gap in the direct vicinity of the pivoting axle.

3. The device of claim 1, characterized in that the predetermined trapping region denotes a second gap between the vehicle body part and the support element and/or a third gap between the support element and the component.

4. The device of claim 1, characterized in that the support element is electrically insulated from the component and/or the vehicle body part.

5. The device of claim 1, characterized in that the sensor element is part of the support element.

6. The device of claim 1, characterized in that the sensor element is attached to the support element by means of a bonding layer and/or clip closure and/or screwed connection and/or plug-in connection.

7. The device of claim 1, characterized in that a laterally arranged panel element is provided between the component and/or the vehicle body part, and in that the sensor element is part of the panel element.

8. The device of claim 7, characterized in that the panel element is attached to the support element.

9. The device of claim 7, characterized in that the panel element is attached in an electrically insulated fashion to a pivoting axle for the tailgate, or in that the panel element is attached in an electrically insulated fashion to the component or to the vehicle body part in the vicinity of a pivoting axle for the component.

10. The device of claim 1, characterized in that a further sensor element is provided which is arranged on that edge of the component where there is a risk of trapping and/or on that edge of the vehicle body part where there is a risk of trapping.

11. The device of claim 1, characterized in that at least one of the sensor elements has a contactless proximity sensor.

12. The device of claim 1, characterized in that at least one of the sensor elements is embodied as an electrically conductive coating and/or wire electrode and/or foil and/or piece of sheet metal.

13. The device of claim 1, characterized in that the support element has a gas pressure spring and/or is acted on by a spring-elastic element.

14. The device of claim 1, characterized in that the anti trapping device has an open-loop control and evaluation device which is coupled to the sensor elements, evaluates sensor signals of the sensor elements and which controls the anti-trapping protection as a function of the evaluation.

15. The device of claim 14, characterized in that a drive motor is provided which moves the component as a function of an open-loop control operation of the open-loop control and evaluation device, wherein for an opening and/or closing process of the component the drive motor acts on an adjustment mechanism, and wherein the component is connected to this adjustment mechanism via a driver.

16. A motor vehicle of claim 1 having a sensor-controlled anti-trapping device.

17. The motor vehicle of claim 16, characterized in that the component is embodied as a tailgate, as a trunk lid, as a sliding door, as a side door and/or as a sunroof or tilt and slide sunroof of the motor vehicle.
